(19) United States
(12) Patent Application Publication
(10) Pub. No.: US 2007/0247862 A1
(43) Pub. Date: Oct. 25, 2007

(54) LIGHTING OR SIGNALLING DEVICE WITH DEPTH EFFECT

(75) Inventors: Alcina TANGHE, Jouars Pontchartrin (FR); Jean-Claude GASQUET, Saint Clement (FR); Benjamin THIERRY, Palis (FR)

Correspondence Address: MATTHEW R. JENKINS, ESQ., 2310 FAR HILLS BUILDING, DAYTON, OH, 45419, US

(73) Assignee: VALEO VISION, Bobigny Cedex (FR)

(21) Appl. No.: 11/738,593

(22) Filed: Apr. 23, 2007

(30) Foreign Application Priority Data
Apr. 24, 2006 (FR) 06 03 640

(51) Int. Cl. B60Q 1/56

(52) U.S. Cl. 362/498; 362/499; 362/540

(57) ABSTRACT

A lighting or signalling device in which a particular output unit of the device in question is formed, the output unit consisting of a stack of screens, independent of one another; each screen comprises a plurality of optical patterns produced in its thickness, able to divert light signals emitted by a light source; the spread of the light beam emerging from the device in question is thus adjustable in a first diffusion direction (OX), corresponding, for each screen in question, to a direction parallel to a plane defined by the screen and containing the optical patterns, and in a second diffusion direction (OZ), corresponding to a direction parallel to a plane roughly perpendicular to the planes defined by the screens, the spread on the second diffusion plane depending on the relative positions of the various screens. In this way in particular a “block of illuminated material” effect is obtained.

### BACKGROUND OF THE INVENTION

1. Field of the Invention

An object of the present invention is a lighting or signalling device having a depth appearance. The aim of the invention is essentially to propose a solution for meeting constant innovation requests from motor manufacturers, in particular in terms of style of certain types of automobile headlight devices; to this end, it proposes a particular technical design adaptable to various types of lighting and/or signalling device.

The field of the invention is, in general terms, that of lighting and signalling applied to motor vehicles. In this field, various types of device are known, amongst which there are essentially the following devices, directly related to the invention:
lighting devices situated at the rear of the vehicle with, in particular, the reversing lights;
signalling devices situated at the front (or on the side) of the vehicle with, in particular, direction indicators, flashing repeaters and DRLs (Daytime Running Light, in English terms) or daytime running lights;
signalling devices situated at the rear of the vehicle with, in particular, fog lights, direction indicators and stop lights, “raised stop” lights;
lighting devices participating in the style, with for example style lines illuminated on the wings of the vehicle, door trim or roof lighting.

2. Description of the Related Art

All the devices mentioned are regularly the subject to technical changes that make it possible to respond to certain expectations in terms of style. In particular, motor manufacturers have for some time been addressing demands in terms of innovation that must meet several requirements, amongst which there are in particular the intention:
to obtain a lighting or signalling device having an appearance of depth when it is switched off;
to conceal a light source used in the device in question, to make it non-locatable and not directly visible, whether the device is switched on or off;
to obtain a fully switched-on appearance when the function fulfilled by the device in question is active;
to create a style effect with an impression of the appearance of secondary light sources masking the true origin of the light.

Up to the present time, various solutions have been proposed to meet some of these requirements, in particular the requirements consisting of creating a style effect while masking the true origin of the light; in particular, it has been proposed to position a screen, or an element of the cap type, in front of the light source of a lighting or signalling device in question; it has also been proposed to create, by means of offset light sources, light returns onto reflectors of a headlight device in question, thus creating a lighting of the indirect type; finally, it has been proposed to create screens, disposed opposite a light source of a headlight device in question, having a plurality of through cavities forming light passages of the reflector type.

However, all these solutions are now known, and do not meet the requirements for innovation expected by manufacturers; moreover, none of these solutions afforded a satisfactory response in particular to the problem consisting of obtaining a fully switched-on appearance when the function fulfilled by the lighting or signalling device is active—an appearance normally referred to as “block of switched-on material”.

What is needed, therefore, is a system and method that overcomes one or more of the problems in the prior art.

### SUMMARY OF THE INVENTION

The object of the invention proposes a solution to the problems and drawbacks that have just been disclosed. In general terms the invention proposes a lighting or signalling device in which a particular output block of the device in question is formed, the output block consisting of a stack of screens independent of one another; each screen comprises a plurality of optical patterns, produced in its thickness, able to divert light signals emitted by a light source of the device in question; the spread of the light beam emerging from the lighting or signalling device in question is thus adjustable according to a first diffusion direction, corresponding, for each screen in question, to a direction parallel to the plane defined by the screen and containing the optical patterns, and in a second diffusion direction corresponding to a direction parallel to a plane roughly perpendicular to the planes defined by the screens, the spread on the second diffusion plane depending on the relative positions of the various screens.

The invention therefore concerns essentially a lighting or signalling device for a motor vehicle, comprising in particular at least one light source emitting a light beam, consisting of a plurality of light signals, in the direction of an output block of the lighting or signalling device, characterized in that the output block comprises in particular a stack of screens, the said stack consisting of at least a first screen and a second screen, each screen comprising an entry face receiving the light signals and an exit face, the entry face and the exit face of each screen being joined by a top face and a bottom face defining between them a screen thickness, at least one of the screens comprising at least one optical pattern produced in the thickness of the screen in question, consisting of a through cavity produced in the screen that comprises it.

Apart from the principal devices that have just been mentioned in the previous paragraph, the device according to the invention can have one or more complementary characteristics among the following:
the top face and the bottom face are planar;
the top face and the bottom face are parallel;
each optical pattern consists of a through cavity produced in the screen that comprises it;
the optical patterns on one and the same screen are disposed on at least one curve parallel to the entry face of the screen in question;
the optical patterns on one and the same screen are disposed on at least a first curve and a second curve parallel to each other;
the optical patterns disposed on a given curve are either exclusively convergent or exclusively divergent;
the optical patterns are disposed, progressing from the entry face to the exit face of each screen, on a first curve comprising exclusively convergent optical patterns, then on a second curve comprising exclusively convergent optical patterns, and then on a third curve comprising exclusively divergent optical patterns;
two optical patterns on one and the same screen are offset with respect to each other, the two optical patterns not intercepting the same light signal;
the light signals are distributed in light planes parallel to the top face of each screen, the optical patterns of one of the screens intercepting all the light signals on a light plane;
the light signals enter the screens perpendicular to the entry face of each screen in question;
any pair of optical patterns consisting of a first optical pattern on a first screen and a second optical pattern on a second screen in contact with the first screen is disposed so that the first optical pattern and the second optical pattern have an offset in a direction perpendicular to the exit face;
the device comprises between three and seven stacked screens;
the thickness of each screen is between two and six millimeters;
the exit face of each screen is curved;
the curved character of the screens creates an overall rounded exit face of the stack of screens;
two entry faces of two consecutive screens in the stack of screens are aligned;
two entry faces of two consecutive screens in the stack of screens are offset in a direction perpendicular to the exit axis;
the screens constituting the stack of screens are identical in shape;
the screens are produced from a transparent material;
the screens are produced from polymethyl methacrylate (PMMA);
two consecutive screens in the stack of screens are fixed to each other by means of an ink placed between the two screens in question and heated by laser.

The present invention also relates to a screen in the stack of screens present in the lighting or signalling device having the main characteristics and possibly one or more secondary characteristics that have just been mentioned, the screen comprising an entry face and an exit face, the entry face and the exit face of each screen being joined by a top face and a bottom face defining a screen thickness, characterized in that the screen comprises at least one optical pattern produced in the thickness of the screen in question.

These and other objects and advantages of the invention will be apparent from the following description, the accompanying drawings and the appended claims.

The present invention also relates to a motor vehicle equipped with a lighting or signalling device comprising the main characteristics and possibly one or more of the complementary characteristics that have just been mentioned.

The invention and its various applications will be better understood from a reading of the following description and an examination of the figures that accompany it.

### BRIEF DESCRIPTION OF THE DRAWINGS

These are presented only by way of indication and are in no way limiting of the invention. The figures show:

FIG. 1 is an example of a screen according to the invention, participating in the lighting or signalling devices according to the invention;

FIG. 2 is a view in section of an example of this screen according to the invention, illustrating a distribution of the light signals according to a first diffusion direction;

FIGS. 3A, 3B and 3C show a first example of a stack of screens within a device according to the invention, and two alternatives of forms of exit beams possible with this first example;

FIGS. 4A and 4B show a second example of a stack of screens within a device according to the invention, and a form of exit beam possible with this second example;

FIGS. 5A, 5B and 5C show a third example of a stack of screens within a device according to the invention, and a form of exit beam possible with this third example.

### DESCRIPTION OF PREFERRED EMBODIMENTS

The various elements appearing in several figures will have kept the same reference, unless otherwise indicated.

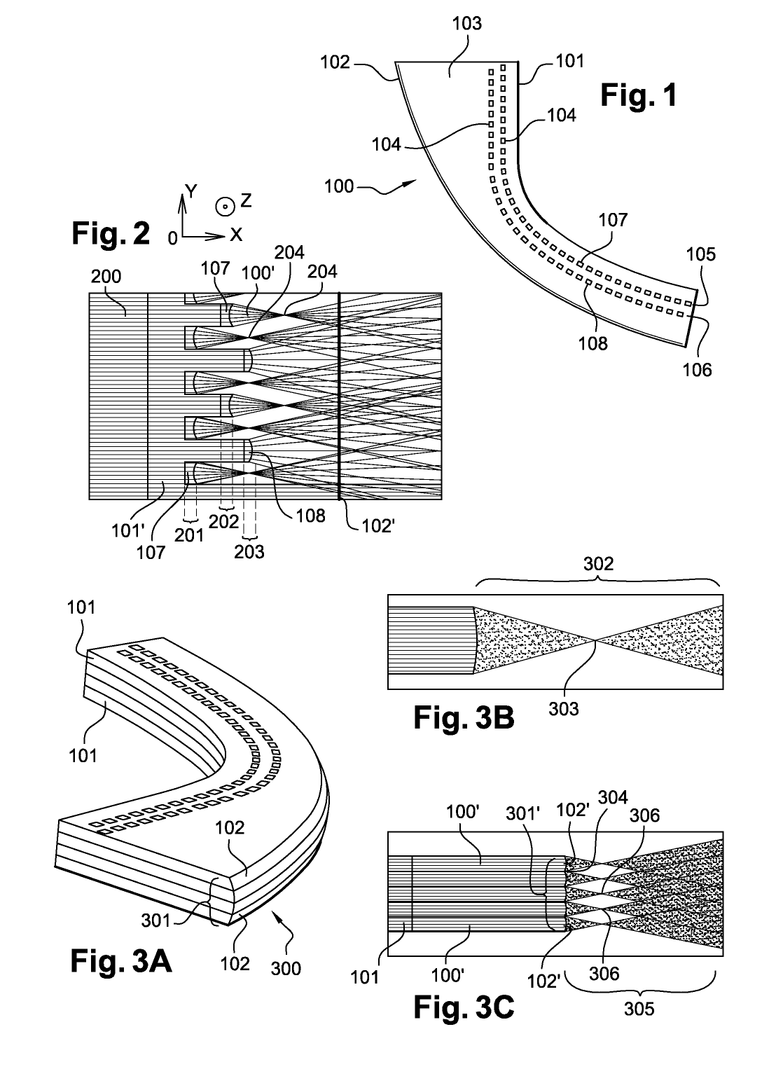

FIG. 1 depicts an example of a screen or optical system 100 according to the invention, intended to be positioned at an exit unit of a lighting or signalling device, in particular for a motor vehicle. The screen 100 is produced from a transparent material, that is to say a material that can have light passed through it; in a particular example, the material used is polymethyl methacrylate (PMMA) or special guide polycarbonate (PC). The screen 100 has the form of a plate, with an entry face 101 intended to receive light signals 200, visible in FIG. 2, an exit face 102, visible from the outside of the lighting or signalling device in which the screen 100 is intended to be positioned, a top face 103 and a bottom face, not visible in the figures.

In general terms, it is signified hereinafter that two screens 100 have the same form if they are identical with regard to the dimensions and relative positionings of the four faces that have just been mentioned. The measurement of the distance between the bottom face and the top face gives the thickness of the screen 100.

In the example shown, the top face and the bottom face are planar and parallel, thus conferring on the screen the form of a plate. They could also be regulated surfaces, that is to say generated by a straight line that moves according to a predetermined law. They can also be planar and not be parallel to each other and therefore form an angle with each other. The embodiment with planar surfaces, or regulated according to the same law, is a particularly advantageous characteristic during an operation of stacking the screens 100, a stacking that will be detailed below.

The entry face 101 and the exit face 102 are curved, their radius of curvature being able to be infinite, the entry 101 and exit 102 faces then having a straight line as a generatrix. In the present description the term “curve” means lines, rows or surfaces whose radius may tend towards infinity, the lines or rows then being straight lines and the surfaces planes. The curves defined by the sections of these entry and exit faces in a longitudinal or transverse plane are not necessarily parallel. Their form is above all determined by the function of the device that they equip, and by the position of the device on the vehicle in question.

In the example depicted, a plurality of optical patterns 104 are present at the screen 100. In this example, each optical pattern 104 consists of a through cavity that creates a hole in the thickness of the screen 100, thus constituting reflectors. The optical patterns are here disposed on a first curved row 105 and on a second curved row 106, parallel to the entry face 101, the first curved row 105 being the row closest to the entry face. The first curved row 106 consists of optical patterns of the convergent type 107, while the second curved row 106 consists of divergent or convergent optical patterns 108.

FIG. 2 shows a second example of a screen or optical system 100′, in plan view, that is to say positioned above the top face 103. In this example, the entry 101′ and exit 102′ faces are straight, aligned with an axis OY, essentially for reasons of simplification of the figure. The entry face 101′ receives a plurality of light signals 200, which issue from a light beam emitted from at least one light source, not shown, of the lighting or signalling device according to the invention. The light source can be of a conventional type, that is to say a halogen or Xenon lamp, or of the light-emitting diode type.

The light beams reach the entry face 101′ in the form of a parallel beam, all these light signals being parallel to one another; the light signals reach the entry face 101 while being perpendicular to the latter; the light signals reaching the entry face 101 while being perpendicular to the latter constitute a light plane. The light signals are here oriented along an axis OX, an axis OZ directed upwards and perpendicular to the top face 103 coming to supplement the other two axes that have just been mentioned in order to form an orthogonal reference frame (OX, OY, OZ). In practice, corresponding to the normal conditions of positioning of screens in the device according to the invention, the axis OZ is vertical.

A parallel beam according to various technical solutions, in particular by using a lamp associated with a recuperating cap, or a lamp associated with a Fresnel screen or a lamp associated with a reflector, or a light-emitting diode associated with a Fresnel system, directly produced on the entry face 101 or 101′ of the optical system 100 or 100′.

This Fresnel system can consist of a conventional Fresnel lens, preferably of revolution about the emission axis of the light source used. It can also consist of a cylindrical Fresnel lens, preferably linear in order to simplify manufacture thereof, and in particular removal from the mould. In the latter case, the beam is collimated solely in the plane parallel to the screen constituting the optical system 100 or 100′.

Starting from the entry face 101′ and moving towards the exit face 102′, the screen 100′ comprises a first series of convergent optical patterns 107 disposed on a first curve 201, then a second series of convergent optical patterns 107 disposed on a second curve 202, and then a third series of divergent optical patterns 108 disposed on a third curve 203, the three curves being parallel to one another and parallel to the entry face 101′. The arrangement of the optical patterns is such that all the light rays 200 are intercepted, each light ray being intercepted only once, that is to say by a single optical pattern. Such an arrangement is an example that makes it possible to give a multisource appearance to the lighting or signalling devices in which the screen 100′ is disposed, the actual source being masked by virtual secondary light sources, corresponding to convergence points 204 present in the body of the screen 100′:
at the exit from the convergent patterns 107, and
in front, looking at the direction of travel of the light beams, of the divergent optical patterns 108, the latter convergence points not being shown for reasons of clarity of the figure.

In general terms, the presence of optical patterns 104 contained in the material of the screens according to the invention on the one hand ensures the return of some of the light, for example sunlight, entering the lighting or signalling device through the exit face of the screen in question, thus giving a flashing appearance to the device in question, even when the light source that it includes is not switched on, and secondly also masks the actual sources at the origin of the beams, thus improving the homogeneity of the illuminated system.

FIG. 3A shows a first example of a stack 300, along the axis OZ, of optical systems or screens having the same form as the form of the screen 100. In this example, the entry faces 101 of each screen 100 are aligned, and the exit faces 102 of each screen 100 are curved, so that the stack 300 has an overall exit face 301, consisting of the juxtaposition of the exit faces 102 of each screen 100, that is continuously rounded, the global exit face 301 having neither discontinuities nor change of direction areas. As shown in FIG. 3B, there is thus obtained, at the exit from the lighting or signalling device comprising the stack 300, a distribution 302 of the exit light beam, with a principal point of convergence 303 of the exit light beam.

In a close example of a stack 300′, visible in FIG. 3C, in which the entry faces 101′ of each screen 100′ are aligned and in which the exit faces 102 of each screen 100′ are curved but in which change of direction zones 304 are present on a global exit face 301′ at the junction of each plate, there is obtained, at the exit from the lighting or signalling device containing the stack 300′, a distribution 305 of the exit light beam, with as many points of convergence 306 of the global exit beam as there are screens 100′, five in the present case. The points of convergence 306 are aligned in a direction parallel to the entry faces 101′; they are thus contained in a vertical plane.

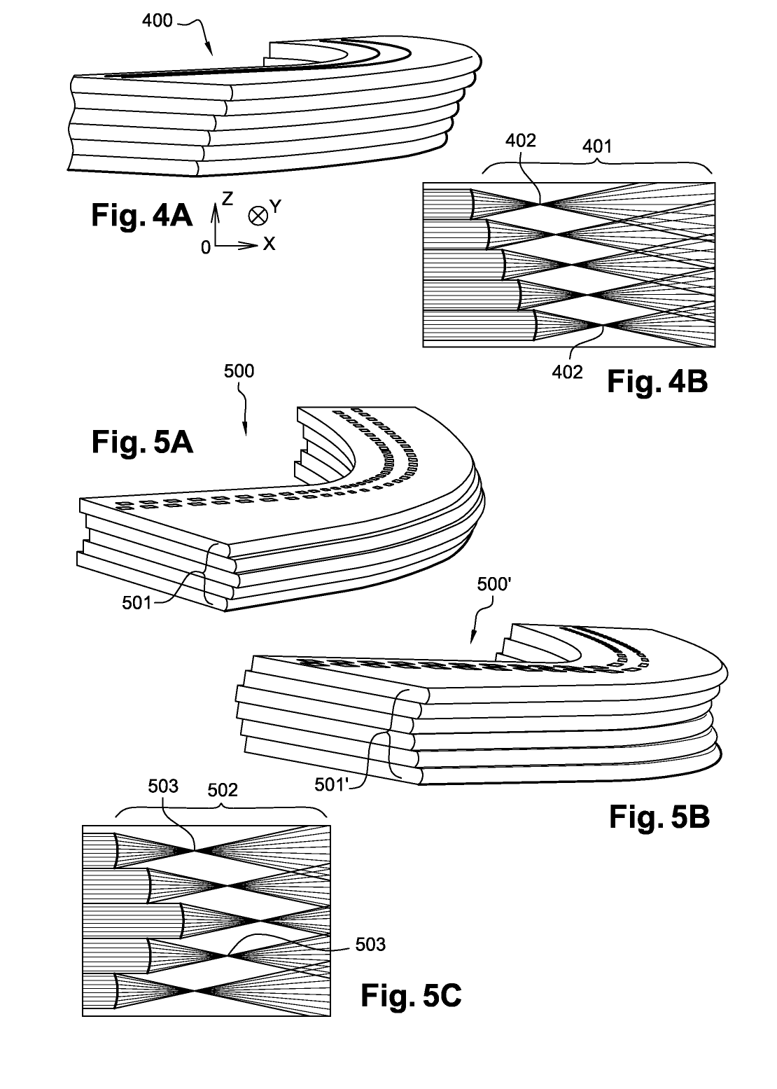

FIG. 4A shows an example of the stack 400 in which the screens 100 are progressively offset along the axis OX. As shown in FIG. 4B, there is then obtained, at the exit from the lighting or signalling device comprising the stack 400, a distribution 401 of the exit light beam with as many points of convergence 402 of the global exit beam as there are screens 100, five in the present case. The points of convergence 402 are aligned in a direction parallel to the entry face 101 and are thus contained in an oblique plane.

FIG. 5A, and respectively FIG. 5B, shows an example of a stack 500, and respectively 500′, in which the screens 100 are disposed so as to have a global exit face 501 and respectively 501′, in a protrusion and respectively in a hollow.

As shown in FIG. 5C, there is then obtained, at the exit from the lighting or signalling device containing the stack 500, a distribution 502 of the exit light beam, with as many points of convergence 503 of the global exit beam as there are screens 100, five in the present case. The points of convergence 503 are disposed on a curve parallel to the global exit face 501.

In certain embodiments, it is chosen not to superimpose the optical patterns on the vertical axis, corresponding to the axis OZ. The operation of stacking the various screens can be carried out by any appropriate technique. In particular, it is possible to dispose a specific ink between two successive screens to be stacked, advantageously at areas with no optical patterns. This ink converts the light energy emitted by the laser into thermal energy, which enables one or more screens constituting the stack to be heated locally and subsequently to ensure connection by thermofusion of the thermal plastic material. It is also possible to provide this connection via adapted mechanical systems.

The various embodiments of the invention that have just been detailed by way of example thus make it possible to achieve the various objectives sought, namely an appearance of depth even in a switched-off position, the concealment of the light source in the switched-off or on position, a “block of switched-on material” appearance on the switched-on position and an impression of the appearance of secondary light source masking the true origin of the light.

While the form of apparatus herein described constitutes a preferred embodiment of this invention, it is to be understood that the invention is not limited to this precise form of apparatus, and that change may be made therein without departing from the scope of the invention which is defined in the appended claims.

What is claimed is:

1. A lighting or signalling device for a motor vehicle, comprising: at least one light source emitting a light beam, comprising a plurality of light signals, in the direction of an output block of the lighting or signalling device, wherein the output block comprises a stack of screens, said stack of screens comprising at least a first screen and a second screen, each of said first and second screens comprising an entry face receiving said plurality of light signals and an exit face, said entry face and said exit face of each screen being joined by a top face and a bottom face defining between them a screen thickness, at least one of said first or second screens comprising at least one optical pattern produced in the thickness of the screen in question, comprising a through cavity produced in the screen that comprises it.

2. A lighting or signalling device according to the claim 1, wherein said top face and said bottom face are planar or regulated.

3. A lighting or signalling device according to the claim 1, wherein said top face and said bottom face are parallel.

4. A lighting or signalling device according to the claim 1, wherein said top face and said bottom face are planar and form an angle to each other.

5. A lighting or signalling device according to claim 1, wherein said at least one optical pattern on one and the same screen are disposed on at least one curve.

6. A lighting or signalling device according to claim 1, wherein said at least one optical pattern defines a curve that is parallel to said entry face of the screen.

7. A lighting or signalling device according to claim 1, wherein said at least one optical pattern comprises two optical patterns on one and the same screen are disposed according to at least a first curve and a second curve.

8. A lighting or signalling device according to claim 7, wherein said first curve and said second curve are parallel to each other.

9. A lighting or signalling device according to claim 5, wherein said at least one optical pattern comprises a plurality of optical patterns disposed on a given curved row and are either exclusively convergent on the first level or convergent or divergent on the other levels.

10. A lighting or signalling device according to claim 1, wherein said at least one optical pattern is disposed, progressing from said entry face to said exit face of each screen, on a first curve comprising exclusively convergent optical patterns, then on a second curve comprising exclusively convergent optical patterns, and then on a third curve comprising exclusively divergent optical patterns.

11. A lighting or signalling device according to claim 1, wherein said at least one optical pattern comprises two optical patterns on one and the same screen that are offset with respect to each other, the two optical patterns not intercepting the same light signal.

12. A lighting or signalling device according to claim 1, wherein said plurality of light signals are distributed in light planes parallel to the top face of each screen, the optical patterns of one of the screens intercepting all the light signals on a light plane.

13. A lighting or signalling device according to claim 5, wherein the light signals enter the screens perpendicular to the entry face of each screen in question.

14. A lighting or signalling device according to claim 1, wherein any pair of optical patterns comprises a first optical pattern on a first screen and a second optical pattern on a second screen in contact with the first screen disposed so that the first optical pattern and the second optical pattern have an offset in a direction (OX) perpendicular to the exit face.

15. A lighting or signalling device according to claim 1, which comprises between three and seven stacked screens.

16. A lighting or signalling device according to claim 1, wherein the thickness of each screen is between two and six millimeters.

17. A lighting or signalling device according to claim 1, wherein said exit face of each screen is curved.

18. A lighting or signalling device according to claim 1, wherein the curved character of the screens creates an overall rounded exit face of the stack of screens.

19. A lighting or signalling device according to claim 1, wherein two entry faces of two consecutive screens in the stack of screens are aligned.

20. A lighting or signalling device according to claim 1, wherein two entry faces of two consecutive screens in the stack of screens are offset in a direction perpendicular to the exit face.

21. A lighting or signalling device according to claim 1, wherein the screens constituting the stack of screens are identical in shape.

22. A lighting or signalling device according to claim 1, wherein the screens are produced from a transparent material.

23. A lighting or signalling device according to claim 1, wherein the screens are produced from polymethyl methacrylate or polycarbonate.

24. A lighting or signalling device according to claim 1, wherein two consecutive screens in the stack of screens are fixed to each other by means of an ink placed between the two screens in question and heated by laser.

25. A screen for use in a lighting or signalling device wherein said screen comprises: an entry face and an exit face, said entry face and said exit face of said screen being joined by a top face and a bottom face defining a screen thickness, wherein the screen comprises at least one optical pattern produced in the thickness of the screen.

26. A motor vehicle equipped with a lighting or signalling device according to claim 1.
